(19) United States
(12) Patent Application Publication
(10) Pub. No.: US 2023/0060325 A1
(43) Pub. Date: Mar. 2, 2023

(54) DEEP CAUSAL LEARNING FOR ADVANCED MODEL PREDICTIVE CONTROL

(71) Applicant: 3M INNOVATIVE PROPERTIES COMPANY, St. Paul, MN (US)

(72) Inventors: Gilles J. Benoit, Minneapolis, MN (US); Nicholas A. Johnson, Woodbury, MN (US)

(21) Appl. No.: 17/797,940

(22) PCT Filed: Feb. 19, 2021
(86) PCT No.: PCT/IB2021/051443

§ 371 Date: Aug. 5, 2022

Related U.S. Application Data
(60) Provisional application No. 62/982,884, filed on Feb. 28, 2020.

(51) Int. Cl. G05B 13/04

(52) U.S. Cl. CPC G05B 13/048

(57) ABSTRACT

Method for predictive control of a system having subsystems. The method includes providing signal injections relating to performance of the system. The signal injections include various operational controls for the system or its subsystems. Response signals corresponding with the signal injections are received, and a utility of those signals is measured. Based upon the utility of the response signals, data relating to operational controls is modified to optimize performance of the system via its subsystems.

### BACKGROUND

Model predictive control (MPC) is an advanced method of process control that is used to control a process while satisfying a set of constraints. The multivariable control algorithm uses the following to calculate the optimum control moves: an internal dynamic model of the process; a history of past control moves; and an optimization cost function J over the receding prediction horizon. The internal model is used to predict the change in the dependent variables of the modeled system that will be caused by changes in the independent variables. Its precision and accuracy are key to achieving high value and performance.

### SUMMARY

A first method for predictive control of a system includes injecting randomized controlled signals in subsystems of the system and ensuring the signal injections occur within normal operational ranges and constraints. The method also includes monitoring performance of the system or the subsystems in response to the controlled signals, computing confidence intervals about the causal relationships between the system or the subsystems performance and the controlled signals, and selecting optimal signals for the system or the subsystems performance based on the computed confidence intervals.

A second method for predictive control of a system includes providing signal injections for subsystems of the system and receiving response signals corresponding with the signal injections. The method also includes measuring a utility of the response signals, accessing data relating to operation of the system or the subsystems, and modifying the data based upon the utility of the response signals.

A third method for self-calibrated model predictive control of a system includes injecting N randomized controlled signals in subsystems of the system, ensuring the signal injections occur within normal operational ranges and constraints, and monitoring M responses of the system or the subsystems to the controlled signals. The method also includes computing confidence intervals about first-order partial derivatives of the system responses with respect to the signal injections and using a model predictive control algorithm to predict based on the NxM matrix of first-order derivatives an expected change in performance caused by changes in the controlled signals in order to select optimal signals that iteratively improve the system and subsystems performance.

### BRIEF DESCRIPTION OF THE DRAWINGS

FIG. 1 is a diagram illustrating advanced model predictive control for a system having subsystems.

FIG. 2 is a flow chart of a search space method for the system.

FIG. 3 is a flow chart of a signal injection method for the system.

FIG. 4 is a flow chart of a continuous learning method for the system.

FIG. 5 is a flow chart of a memory management method for the system.

### DETAILED DESCRIPTION

Deep Causal Learning (DCL) offers a robust prescriptive analytics platform with broad applicability for process control automation and optimization. DCL computes cause and effect relationships through randomized controlled experimentation, comparing the difference in outcomes between distinct levels of one independent variable (actions/settings/policies). If one represents the system response surface as a noisy vector-valued function F, where inputs are vectors of settings for each of the system independent variables and outputs are vectors of values representing the response of the system dependent variables, then DCL can be interpreted as an active machine learning technique to estimate the value of each element of the system Jacobian matrix J, i.e. the first-order partial derivatives of the vector-valued function F. In addition, DCL can also quantify interaction effects between input variables and estimate the value of the second-order partial derivatives of the vector-valued function F, represented by an array of Hessian matrices, and even higher-order partial derivatives. Finally, DCL is applicable to complex dynamical systems by providing mechanisms to identify large time delays and high-order dynamics and can be used to estimate the system time-dependent Jacobian matrix. Time-dependent (dynamic state) Jacobian and Hessian matrices are used in process control, in particular for MPC. MPC is broadly applicable to complex dynamic industrial systems and other systems having subsystems.

Examples of DCL algorithms and parameters are disclosed in WO 2020/188331, which is incorporated herein by reference as if fully set forth.

Embodiments of this invention include how DCL enables self-generated and self-calibrated causal models for advanced process control in the form of time-varying Jacobian and Hessian matrices whose matrix elements are evaluated in-situ and in real-time through randomized controlled experimentation, by introducing randomized small perturbation to the process control parameters.

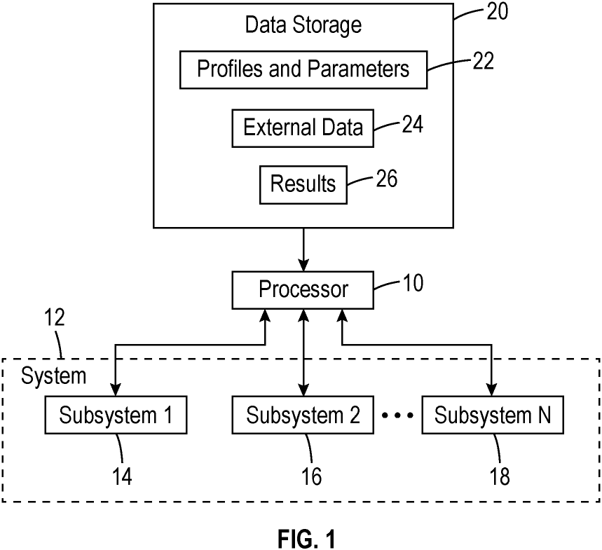

FIG. 1 is a diagram illustrating advanced MPC for a system 12 having subsystems 1-N. A processor 10 is electrically coupled with subsystems 14, 16, and 18 within system 12. Data storage 20, such as an electronic memory, stores profiles and parameters 22, external data 24, and results 26. Results can include, for example, the outcome of injecting signals into the subsystems of system 12. In use, processor 10 injects signals to subsystems 14, 16, and 18 using profiles and parameters 22 and possibly external data 24 in order to evaluate the performance of system 12. Processor 10 stores as results 26 the response to the signal injections, and those responses can be used to optimize performance of system 12 via its subsystems 14, 16, and 18.

DCL measures the cause and effect relationships between discrete independent variables levels (e.g., x_{i,1}, x_{i,1+1}) and their respective outcomes (F_{i,1}, F_{i,1+1}) while keeping all other independent variables constant. This information can be used to estimate the value of the first partial derivative of F with respect to xᵢ: dF/dxᵢ = (F_{i,1+1} - F_{i,1}) / (x_{i,1+1} - x_{i,1}). This represents one matrix element of the system’s Jacobian matrix shown below:

$$\text{J=} \left[\frac{\partial \text{f}}{\partial {x}_{1}} … \frac{\partial \text{f}}{\partial {x}_{n}}\right] = \left(\begin{matrix}\frac{\partial {f}_{1}}{\partial {x}_{1}} & … & \frac{\partial {f}_{1}}{\partial {x}_{n}} \\ ⋮ & ⋱ & ⋮ \\ \frac{\partial {f}_{m}}{\partial {x}_{1}} & ⋯ & \frac{\partial {f}_{m}}{\partial {x}_{n}}\end{matrix}\right)$$

For each matrix element, DCL not only estimates its true value but also the uncertainty surrounding that estimate as a confidence interval. As data accumulates over time, the confidence intervals become narrower corresponding to an increase in the precision of the estimate of the Jacobian matrix. Furthermore, DCL can monitor the dependent variables over time after each change in the independent variables and compute a time-varying Jacobian J(t) that captures the dynamics of the system response such as time-varying causal effects, time delays, transient effects and/or higher-order harmonics.

This time-varying Jacobian matrix and its associated confidence intervals can be used as the internal dynamic causal model in an MPC algorithm. Monte Carlo simulation can be used, for example, to generate a large set of different Jacobian matrices for which each matrix element is randomly sampled from within the associated confidence interval, and compute a confidence interval around the predicted outcome of any control move by running a statistical t-test on the set of predicted outcomes associated with this set of randomly generated Jacobian matrices. Unlike traditional MPC where the model uncertainty is not captured and/or known, the approach described herein allows for risk-adjusted optimization of process controls by providing precise quantification of the expected utility and variance associated with each possible process control move.

In many instances, the system response surface can be non-linear and a simple linear approximation is insufficient to accurately optimize process control decisions. While the Jacobian matrix provides a linear approximation of the system response, DCL can identify ordinal, spatial and/or temporal characteristics in the form of external variables (EVs) across which the elements of the Jacobian matrix are statistically different. In that case, DCL initiates a process of clustering, analogous to piece-wise linear approximation, whereby different Jacobian matrices provide a local linear approximation within each cluster. Clusters can be generated through a variety of classification techniques, for example recursive partitioning algorithms such as conditional inference trees. Alternatively, regression models, for example Gaussian Mixture Regression models, can be used to contextually approximate the value of the coefficients as a function of EVs, allowing for a continuous set of coefficient and matrices across those environmental factors.

The internal model of the MPC can be further refined by computing higher-order partial derivatives in the same fashion. As an example, DCL can measure the causal effects associated with varying two independent variables xᵢ and xⱼ and compute the matrix element of the Hessian matrix of the system:

$$\text{H=} \left[\begin{matrix}\frac{{\partial }^{2} f}{\partial {x}_{1}^{2}} \frac{{\partial }^{2} f}{\partial {x}_{1} \partial {x}_{2}} ⋯ \frac{{\partial }^{2} f}{\partial {x}_{1} \partial {x}_{n}} \\ \frac{{\partial }^{2} f}{\partial {x}_{2} \partial {x}_{1}} \frac{{\partial }^{2} f}{\partial {x}_{2}^{2}} ⋯ \frac{{\partial }^{2} f}{\partial {x}_{2} \partial {x}_{n}} \\ ⋮ ⋮ ⋱ ⋮ \\ \frac{{\partial }^{2} f}{\partial {x}_{n} \partial {x}_{1}} \frac{{\partial }^{2} f}{\partial {x}_{n} \partial {x}_{2}} ⋯ \frac{{\partial }^{2} f}{\partial {x}_{n}^{2}}\end{matrix}\right]$$

This set of matrices forms a comprehensive causal model of the underlying system that can be leveraged by a number of decision-making and process control algorithms such as MPC. As is often the case in machine learning, greater system complexity can lead to overfitting and poor performance in the real world. DCL leverages both confidence intervals and baseline monitoring to assess the risk/reward of increasing the internal model complexity based on the available data and to adjust the model complexity based on evidence that it is in fact delivering greater value in the real world. In addition to enabling advanced model-based process control, the continuous testing of the internal causal model in DCL offers a number of benefits.

Precise in-situ quantification of all the elements of the Jacobian and Hessian matrices allows for accurate determination of the optimum combinatorics of process control moves with high external validity. In many instances, the cross-terms of these matrices may not be well understood and/or characterized because the complexity of the system means that no representative analytical model exists from which they could be numerically be derived, and that data-driven approaches cannot isolate the partial derivative elements (i.e., the effect of a single variable while keeping all others constant) by simply observing highly cross-correlated historical data. As a result, many current methods only provide a sub-optimal solution that optimizes a sum of local / direct effects (e.g., a block diagonal Jacobian matrix is equivalent to treating the system’s sub-processes as independent of one another) rather than providing a true optimum that holistically exploits all the interactions between the system’s sub-processes.

Precise in-situ quantification of time delays and other temporal characteristics further allows optimizing the timing of these combinatorics of process control moves to minimize adverse effects such as instabilities, transient effects, harmonics and more. The MPC may use a direct estimate based on the mean matrix coefficients or a Monte Carlo simulation by sampling within the coefficients confidence intervals to estimate the expected net outcome over time of a combination of process control adjustments and optimize the time delay between those. For example, the MPC may be programmed to maintain the temperature of a space, e.g. a data center, stable around a target value. As the thermal load varies dynamically in the space, the MPC adjusts fan speed settings to improve air mixing and minimize the presence of hot and cold spots. These adjustments induce a transient period during which air flow can be turbulent and may create local high- and low-pressure and temperature points that are detrimental to the space, e.g. compromising the operation of sever racks. These effects can be predicted using time-varying Jacobian matrices to compute system response at different time intervals, and mitigated by optimizing small time delays between the fan speed adjustments to promote destructive interferences, allowing the overall system to reach steady state faster and with fewer negative side effects.

Sparsity of the Jacobian Matrix provides an assessment of gaps and redundancies in the controls (independent variables (IVs)) and sensors (dependent variables (DVs)) available and can be used to estimate the marginal benefit of adding controls and sensors to improve performance, reduce variance and/or minimize risk.

Monitoring of the matrix elements over time provides an indication of the stability of causal effects. DCL adjusts the data inclusion window used to compute the confidence intervals such that if cause and effect relationships are changing over time, only data representative of the current state of the systems are used in their estimation. A drift in the mean value and/or width of the confidence intervals can indicate that the underlying physical cause and effect relationships are changing. In some instances, these changes can be mapped out over time to root causes, such as wear and tear of the equipment or system faults, thus improving the accuracy of system diagnosis and the effectiveness of preventive maintenance. The amplitude of change in the matrix elements can be used to estimate the process gains associated with deploying resources to address the root cause of the change and balance the benefit versus the costs, including opportunity costs, of deploying such resources.

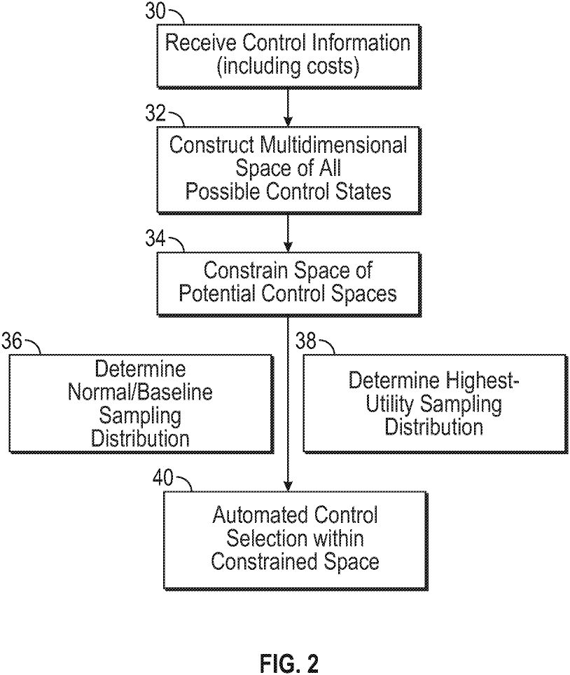

FIGS. 2-5 are flow charts of DCL methods for model predictive control to optimize performance of system 12, for example via profiles and parameters for controlling the subsystems of system 12. These methods can be implemented in, for example, software modules for execution by processor 10.

FIG. 2 is a flow chart of a search space method. The search space method includes the following steps: receive control information (including costs) 30; construct multidimensional space of all possible control states 32; constrain space of potential control spaces 34; determine normal/baseline sampling distribution 36; determine highest utility sampling distribution 38; and automated control selection within constrained space 40.

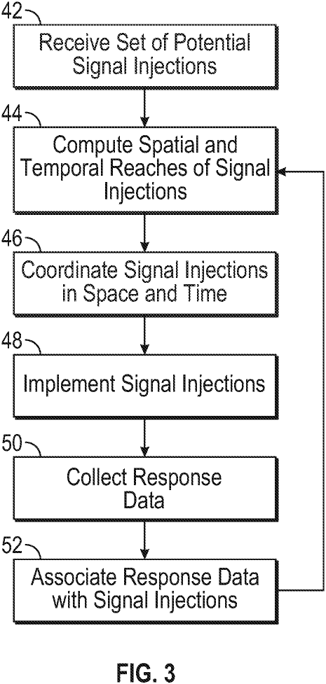

FIG. 3 is a flow chart of a signal injection method. The signal injection method includes the following steps: receive set of potential signal injections 42; compute spatial and temporal reaches of signal injections 44; coordinate signal injections in space and time 46; implement signal injections 48; collect response data 50; and associate response data with signal injections 52.

The signal injections are changes in profiles and parameters for the subsystems of the overall system. These injections do not need to be large changes and generally consist of small perturbations to the control elements within the natural process noise. This allows DCL to operate within normal operations without any noticeable increase in overall process variance. The range of these perturbations (i.e., the search space) can be adjusted over time to reflect changes in the process variance and/or in the operational goals. The responses to signal injection are typically subsystem performance resulting from or related to the changes in profiles and parameters from the signal injections.

For example, the algorithm can perturb values in a look-up table representing profiles and parameters, and then monitor and store the corresponding subsystem performance response. As another example, DCL may perturb the gain values of a PID controller, such as a thermostat, and monitor the response of the system under its control, such as a set of temperature sensors in a space. Temperature readings may be recorded at a single time (e.g., representative of steady state) or at multiple time intervals to capture transient effects.

The temporal and spatial reaches of signal injections relate to, respectively, when and where to measure the response signals to those signal injections that are used for computing causal relationships such as to minimize carry-over and cross-over effects between experiments. DCL tests for independence between the repeated effect measures and automatically adjusts those reaches to maximize both independence and statistical power. The cost of signal injection typically relates to how the signal injection affects overall system, for example signal injection can result in lower or less efficient subsystem performance, and is controlled by the specified experimental range. The queue for signal injection involves the order and priority of signal injections and relies on blocking and randomization to guarantee high internal validity at all times, even when optimizing utility. The utility of responses to signal injection involves the effectiveness of the signal injections or other measures of utility.

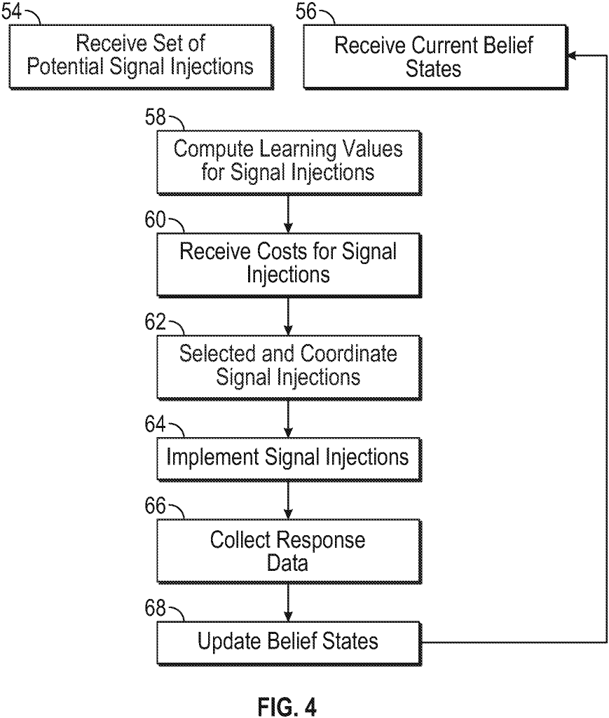

FIG. 4 is a flow chart of a continuous learning method. The continuous learning method includes the following steps: receive set of potential signal injections 54; receive current belief states 56; compute learning values for signal injections 58; receive costs for signal injections 60; select and coordinate signal injections 62; implement signal injections 64; collect response data 66; and update belief states 68.

The belief states are a set of different models of subsystem performance in response to injected signals. For MPC, the belief states consist of the set of coefficients of the Jacobian and Hessian matrices. These belief states may have attached uncertainty values reflecting the likelihood that they are accurate given the current set of trials and knowledge that may tend to confirm or falsify these different models, and the information that can further confirm or falsify the models may be included in this data or derived from the basic characteristics of the particular model and the physics of the underlying system.

The learning value is a measure of the value that knowledge generated as a result of the signal injection may provide to subsequent decision-making by a system, such as determining that a particular profile is more likely to be optimal. For MPC, the reinforcement learning component of DCL controls the ratio of explore phase (random signal injections aimed at increasing the precision of the coefficients of the Jacobian and Hessian matrices) vs exploit phase (signal injections aimed at improving system performance). In the explore phase, DCL may prioritize reducing the uncertainty of the coefficients with the largest impact, e.g. the diagonal terms of the Jacobian and Hessian matrices. In the exploit phase, DCL defers to the MPC itself to drive decision making by leveraging the causal model generated by DCL (i.e., model-based optimization). In other words, while DCL can be used in general to drive decision making, the present application does not aim to replace MPC with DCL but rather to keep MPC in applications where it is already being used and augment it with DCL to continuously test and improve the internal and external validity of the model used by MPC (including accurate characterization of cross terms and time-varying terms) resulting in greater precision and accuracy over time. This approach can be especially beneficial when the optimal state is not expected to converge and requires continuous iterative adjustments instead.

In the sense of a multi-objective optimization, the learning value can include complex trade-offs between operational goals (e.g., performance versus range) and where optimality may vary over time. The learning value may be computed through, for example, predicting the raw number of belief states that may be falsified according to the predictions of a Partially Observable Markov Decision Process (POMDP) or other statistical model, predicted impacts of the signal injection on the uncertainty levels in the belief states in such models, or experimental power analyses computing the reduction in uncertainty and narrowing of confidence intervals based on increasing to the current sample size.

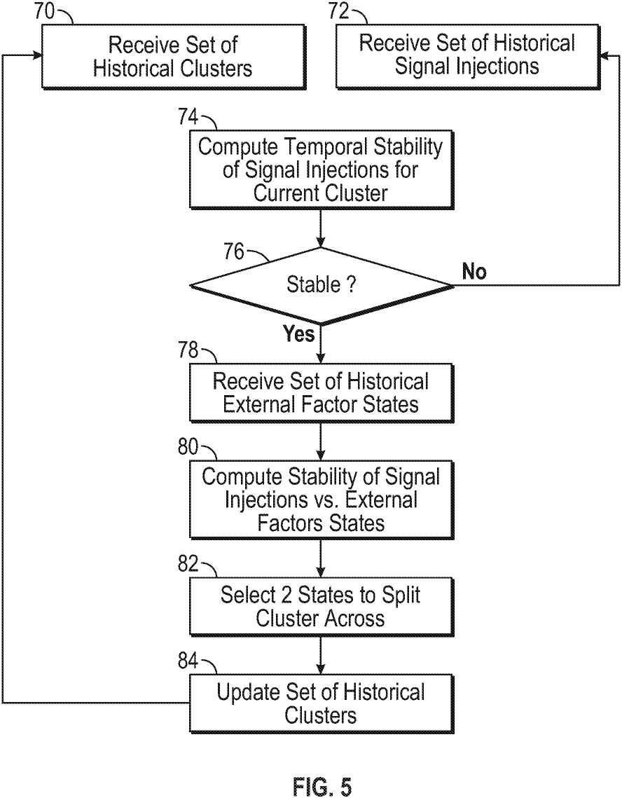

FIG. 5 is a flow chart of a memory management method. The memory management method includes the following steps: receive set of historical clusters 70; receive set of historical signal injections 72; and compute temporal stability of signal injections for current clusters 74. If the signal injections from step 74 are stable 76, then the memory management method executes the following steps: receive set of historical external factor states 78; compute stability of signal injections versus external factors states 80; select two states to split cluster across 82 only if there is enough variance across the two states and enough data within each state (after splitting) to be able to drive decisions in each state (i.e., compute confidence intervals); and update set of historical clusters 84.

A cluster is a group of experimental units that are exchangeable with respect to the measured causal effects. Within each cluster, effect measures are free of bias and/or confounding effects from external factors and follow normal distributions from which estimates of causal effects -not just associations- can be derived. Clustering offers a mechanism to continuously optimize the experimental design as new information about potential effect modifiers arises and allows DCL to operate as a self-organized adaptive clinical trial methodology. Regression models, such as Gaussian Mixture Regression models, can be further used to approximate a continuous causal response surface across the generated clusters..

Table 1 provides an algorithm of an embodiment for automatically generating and applying causal knowledge for model predictive control of a system having subsystems. This algorithm can be implemented in software or firmware for execution by processor 10.

Table 1

| | |
|---|---|
| 1 | inject randomized controlled signals into subsystems of the system based upon changes in profiles and related parameters |
| 2 | ensure signal injections occur within normal operational ranges and constraints |
| 3 | monitor system (or subsystems) performance in response to the signal injections |
| 4 | compute causal knowledge about the relationship between signal injections and monitored system (or subsystems) performance |
| 5 | select optimal signals for the system (or subsystems) performance based on the MPC and possibly external data |

The invention claimed is:

1. A method for predictive control of a system, comprising steps of:
injecting randomized controlled signals in subsystems of the system;
ensuring the signal injections occur within normal operational ranges and constraints;
monitoring performance of the system or the subsystems in response to the controlled signals;
computing confidence intervals about the causal relationships between the system or the subsystems performance and the controlled signals;
using computed confidence intervals to predict an expected change in performance caused by changes in the controlled signals; and
selecting optimal signals that iteratively improve the system and subsystems performance.

2. The method of claim 1, wherein the controlled signals comprise set points, time delays and gain parameters of proportional controllers, integral controllers, derivative controllers, and combinations of controllers.

3. The method of claim 1, wherein the normal operational ranges comprise a multidimensional space of possible control states generated based on control information and operational constraints.

4. The method of claim 1, wherein the selecting step further comprises selecting the optimal signals based upon external data.

5. The method of claim 1, wherein at time T the method predicts future possible states of the system at time T+t under different control signals and selects the optimal control signals that maximizes system performance at T+t, then iteratively repeats this process.

6. A method for predictive control of a system, comprising steps of:
providing signal injections for subsystems of the system;
receiving response signals corresponding with the signal injections;
measuring a utility of the response signals;
accessing data relating to operation of the system or the subsystems; and
modifying the data based upon the utility of the response signals.

7. The method of claim 6, wherein the signal injections comprise set points, time delays and gain parameters of proportional controllers, integral controllers, derivative controllers, and combinations of controllers.

8. The method of claim 6, wherein the accessing step comprises accessing a look-up table.

9. The method of claim 6, wherein the signal injections have a spatial reach.

10. The method of claim 6, wherein the signal injections have a temporal reach.

11. The method of claim 6, wherein the signal injections have multiple temporal reaches at different time intervals.

12. The method of claim 6, wherein the modifying step further comprises modifying the data based upon external data.

13. The method of claim 6, wherein the data comprises a causal model stored as a set of Jacobian and hessian matrices.

14. The method of claim 13, wherein updating the model includes modifying or updating coefficients of the matrices.

15. A method for self-calibrated model predictive control of a system, comprising steps of:
injecting N randomized controlled signals in subsystems of the system;
ensuring the signal injections occur within normal operational ranges and constraints;
monitoring M responses of the system or the subsystems to the controlled signals;
computing confidence intervals about first-order partial derivatives of the system responses with respect to the signal injections;
using a model predictive control algorithm to predict based on the NxM matrix of first-order derivatives an expected change in performance caused by changes in the controlled signals; and
selecting optimal signals that iteratively improve the system and subsystems performance based upon the expected change in performance predicted by the model predictive control algorithm.

16. The method of claim 15, wherein the using step comprises using the NxM matrix of 2^{nd}-order derivatives.

17. The method of claim 15, wherein the using step comprises using the NxM matrix of Nth-order derivatives.

18. The method of claim 15, wherein the using step comprises using the NxM matrix of time-varying derivatives.

19. The method of claim 15, wherein the method optimally balances an explore for updating the derivative estimates versus an exploit for letting the model predictive control algorithm decide what action to take based on the current derivative estimates.
